(19) United States
(12) Patent Application Publication
(10) Pub. No.: US 2026/0107190 A1
(43) Pub. Date: Apr. 16, 2026

(54) LOWER LAYER INACTIVE STATE

(71) Applicant: InterDigital Patent Holdings, Inc., Wilmington, DE (US)

(72) Inventors: Oumer Teyeb, Montreal (CA); Brian Martin, Farnham (GB); Paul Marinier, Brossard (CA); Keiichi Kubota, Tokyo (JP); Martino M. Freda, Laval (CA)

(73) Assignee: InterDigital Patent Holdings, Inc., Wilmington, DE (US)

(21) Appl. No.: 18/912,032

(22) Filed: Oct. 10, 2024

(51) Int. Cl. H04W 36/00; H04W 72/23; H04W 76/27

(52) U.S. Cl. CPC H04W 36/0058; H04W 72/23; H04W 76/27

(57) ABSTRACT

Systems, methods, and instrumentalities are described herein related to lower layer inactive state. A device (e.g., wireless transmit/receive unit (WTRU)) may transition between states. A WTRU may transition between power saving and/or full power operating states. Latency, signaling, processing, etc. may be reduced for transitioning a WTRU between states. A WTRU may operate using an L1/L2 INACTIVE configuration.

### BACKGROUND

Mobile communications using wireless communication continue to evolve. A sixth generation may be referred to as 6G. A fifth generation may be referred to as 5G. A previous (e.g., legacy) generation of mobile communication may be, for example, fourth generation (4G) long term evolution (LTE).

### SUMMARY

Systems, methods, and instrumentalities are described herein related to lower layer inactive state. A device (e.g., wireless transmit/receive unit (WTRU) may transition between states. A WTRU may transition between power saving and/or full power operating states. Latency, signaling, processing, etc. may be reduced for transitioning a WTRU between states. A WTRU may operate using an L1/L2 INACTIVE configuration.

An example device (e.g., WTRU) may include a processor configured to perform one or more actions. For example, a WTRU may receive an indication (e.g., from a network node) to transition to a lower layer inactive state. The WTRU may transition to the lower layer inactive state (e.g., based on the received indication). The WTRU may perform measurements associated with cell re-selection (e.g., in the lower layer inactive state). The WTRU may determine cell re-selection conditions (e.g., criteria) are satisfied. The WTRU may determine that cell re-selection criteria are satisfied, for example, based on the performed measurements. The WTRU may perform cell-reselection from a source cell to a target cell. The WTRU may (e.g., upon cell reselection to the target cell) may apply a configuration associated with the target cell. The WTRU may determine whether the source cell is associated with a first cell group that is different than a second cell group (e.g., that the target cell group is associated with). Based on a determination that the source cell is associated with a first cell group that is different than the second cell group that the target cell is associated with, the WTRU may perform one or more of the following: send an indication to a network node (e.g., indicating that the WTRU is connected to the target cell); send a radio resource control (RRC) complete message; send a request to transition to a lower layer active state; transition to the lower layer active state; etc. Based on a determination that the source cell and the target cell are associated with a same cell group, the WTRU may perform one or more of the following: store the RRC complete message; refrain from sending the RRC complete message; etc.

The WTRU may perform actions based on being in the lower layer inactive state. The WTRU may reduce or stop performing radio resource management (RRM) measurements and/or radio link monitoring (RLM) measurements on a condition that the WTRU is in the lower layer inactive state. The WTRU may reduce or stop monitoring of a physical downlink control channel (PDCCH) on a condition that the WTRU is in the lower layer inactive state.

The WTRU may determine cell groups associated with the one or more candidate cells. The WTRU may receive configuration information (e.g., a configuration) associated with the one or more candidate cells. The one or more candidate cells may be grouped into one or more candidate cell groups. The one or more candidate cell groups may comprise a group of cells within a decentralized unit (DU).

The WTRU may request a transition to the lower layer active state (e.g., based on cell reselection to a target cell associated with a cell group different than that of the source cell). The request to transition to the lower layer active state may include an indication of a cause. The cause may be associated with a cell re-selection from the first cell group to the second cell group. The WTRU may receive an indication from the network node, for example, to transition to a lower layer active state.

The WTRU may monitor for arrival of uplink (UL) data, for example, on a condition that the WTRU is in the lower layer inactive state. The WTRU may receive and/or determine the arrival of UL data. Based on the arrival of the UL data, the WTRU may perform one or more of the following: send a request to transition to a lower layer active state; transition to the lower layer active state; send the stored RRC complete message; send the UL data; etc.

The WTRU may monitor for arrival of downlink (UL) data, for example, on a condition that the WTRU is in the lower layer inactive state. The WTRU may receive and/or determine the arrival of DL data. Based on the arrival of the DL data, the WTRU may perform one or more of the following: send a request to transition to a lower layer active state; transition to the lower layer active state; send the stored RRC complete message; send the DL data; etc.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example RRC connection establishment/setup.

FIG. 3 illustrates an example state transition between INACTIVE and CONNECTED states.

FIG. 4 illustrates example options for functional/protocol split between CU and DU.

FIG. 5 illustrates an example handover procedure.

FIG. 6 illustrates an example flow of cell reselection and RRC complete message transmission and storage.

### EXAMPLE NETWORKS FOR IMPLEMENTATION OF THE EMBODIMENTS

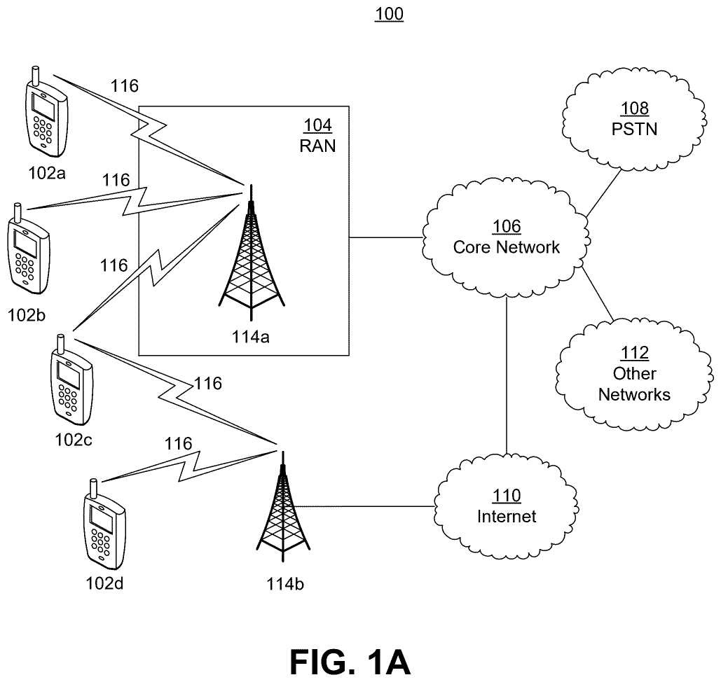

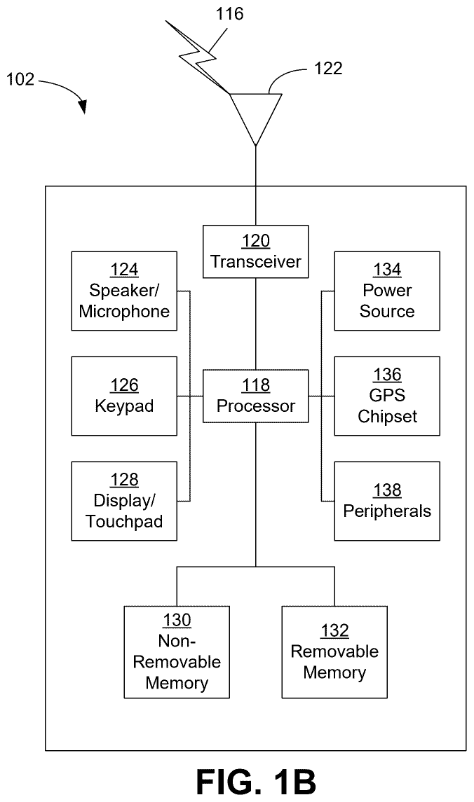

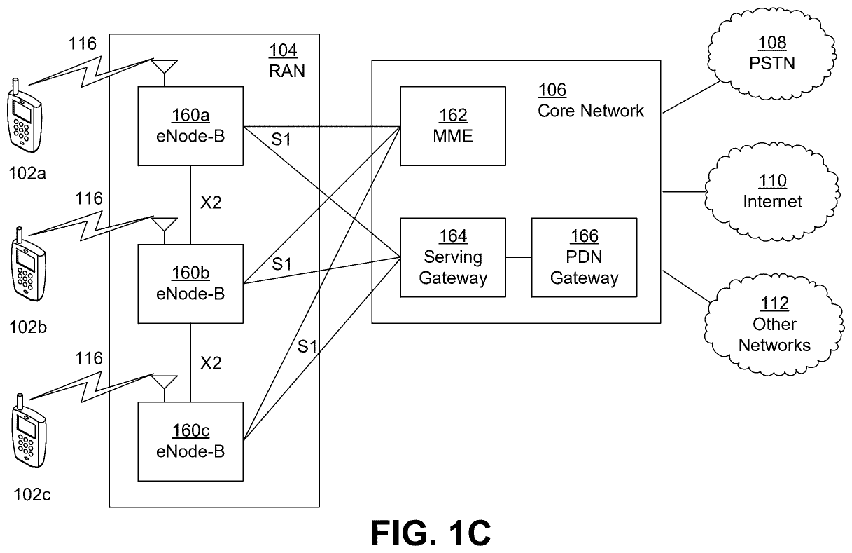

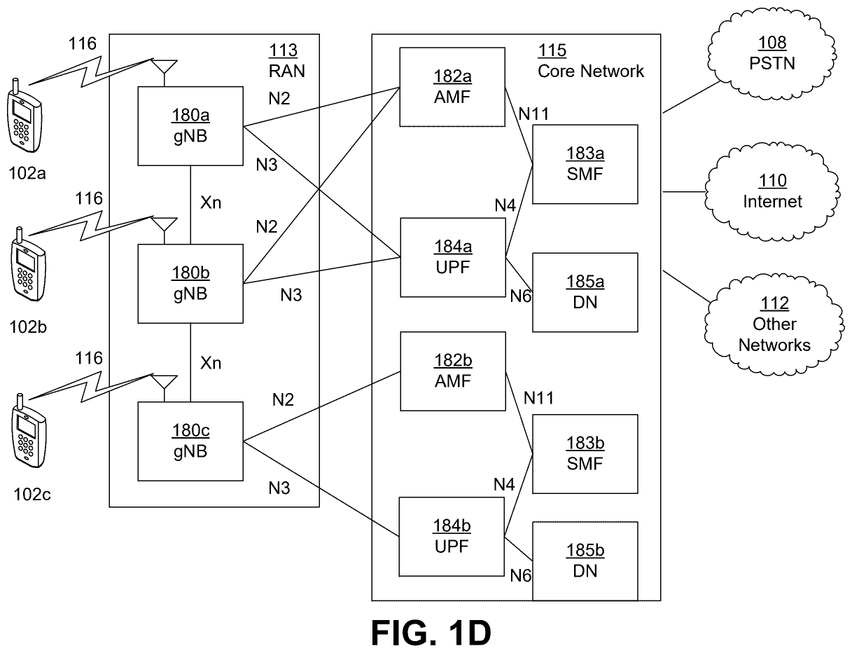

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to lower layer inactive state. A device (e.g., wireless transmit/receive unit (WTRU) may transition between states. A WTRU may transition between power saving and/or full power operating states. Latency, signaling, processing, etc. may be reduced for transitioning a WTRU between states. A WTRU may operate using an L1/L2 INACTIVE configuration.

An example device (e.g., WTRU) may include a processor configured to perform one or more actions. For example, a WTRU may receive an indication (e.g., from a network node) to transition to a lower layer inactive state. The WTRU may transition to the lower layer inactive state (e.g., based on the received indication). The WTRU may perform measurements associated with cell re-selection (e.g., in the lower layer inactive state). The WTRU may determine cell re-selection conditions (e.g., criteria) are satisfied. The WTRU may determine that cell re-selection criteria are satisfied, for example, based on the performed measurements. The WTRU may perform cell-reselection from a source cell to a target cell. The WTRU may (e.g., upon cell reselection to the target cell) may apply a configuration associated with the target cell. The WTRU may determine whether the source cell is associated with a first cell group that is different than a second cell group (e.g., that the target cell group is associated with). Based on a determination that the source cell is associated with a first cell group that is different than the second cell group that the target cell is associated with, the WTRU may perform one or more of the following: send an indication to a network node (e.g., indicating that the WTRU is connected to the target cell); send a radio resource control (RRC) complete message; send a request to transition to a lower layer active state; transition to the lower layer active state; etc. Based on a determination that the source cell and the target cell are associated with a same cell group, the WTRU may perform one or more of the following: store the RRC complete message; refrain from sending the RRC complete message; etc.

The WTRU may perform actions based on being in the lower layer inactive state. The WTRU may reduce or stop performing radio resource management (RRM) measurements and/or radio link monitoring (RLM) measurements on a condition that the WTRU is in the lower layer inactive state. The WTRU may reduce or stop monitoring of a physical downlink control channel (PDCCH) on a condition that the WTRU is in the lower layer inactive state.

The WTRU may determine cell groups associated with the one or more candidate cells. The WTRU may receive configuration information (e.g., a configuration) associated with the one or more candidate cells. The one or more candidate cells may be grouped into one or more candidate cell groups. The one or more candidate cell groups may comprise a group of cells within a decentralized unit (DU).

The WTRU may request a transition to the lower layer active state (e.g., based on cell reselection to a target cell associated with a cell group different than that of the source cell). The request to transition to the lower layer active state may include an indication of a cause. The cause may be associated with a cell re-selection from the first cell group to the second cell group. The WTRU may receive an indication from the network node, for example, to transition to a lower layer active state.

The WTRU may monitor for arrival of uplink (UL) data, for example, on a condition that the WTRU is in the lower layer inactive state. The WTRU may receive and/or determine the arrival of UL data. Based on the arrival of the UL data, the WTRU may perform one or more of the following: send a request to transition to a lower layer active state; transition to the lower layer active state; send the stored RRC complete message; send the UL data; etc.

The WTRU may monitor for arrival of downlink (UL) data, for example, on a condition that the WTRU is in the lower layer inactive state. The WTRU may receive and/or determine the arrival of DL data. Based on the arrival of the DL data, the WTRU may perform one or more of the following: send a request to transition to a lower layer active state; transition to the lower layer active state; send the stored RRC complete message; send the DL data; etc.

Details associated with connection states (e.g., RRC Connection states) and state transitions may be provided herein.

A WTRU may be in one of the following RRC states (e.g., in NR): RRC_CONNECTED (e.g., CONNECTED mode); RRC_INACTIVE (e.g., INACTIVE mode); RRC_IDLE (e.g., IDLE mode); etc.

In CONNECTED mode (e.g., RRC_CONNECTED), the WTRU may be connected (e.g., actively connected) to the network (e.g., with signaling and data radio bearers established (SRB and DRBs)). The WTRU may (e.g., be able to) receive Downlink (DL) data from the network in a unicast fashion and/or send Uplink (UL) data to the network. The mobility of the WTRU from one cell/node to another may be controlled by the network. A network may configure the WTRU to send measurement reports periodically or if (e.g., when) a condition is (e.g., certain conditions are) fulfilled (e.g., a neighbor cell becomes better than a serving cell by more than a certain threshold). The network may (e.g., based on these reports) send the WTRU a handover command to move the WTRU to another cell/node. The network may also configure a conditional handover (CHO), for example, where instead of sending of a measurement report, the WTRU may execute a preconfigured handover command when certain conditions are fulfilled. The network may also send the WTRU a HO command without receiving any measurement report (e.g., based on implementation, such as the determination of current location).

The network can send the WTRU to an IDLE (e.g., RRC_IDLE) state (e.g., when the WTRU has no data activity for more than a certain duration), for example, to save the WTRU battery and save network resources. The WTRU's context may be released at one or more of the following: at the Radio Access Network (RAN) (e.g., the base station (e.g., gNB)), and/or the Core Network (CN). The WTRU may camp (e.g., while in RRC_IDLE) at the best cell (e.g., the cell with the best signal level at the highest priority RAT and highest priority frequency within that RAT) that may facilitate the WTRU establishing the connection via that cell, for example, if a need arises for the WTRU to transition back to the connected state. The WTRU may monitor the downlink paging channel to detect for DL data arrival. The WTRU may initiate the connection setup/establishment procedure, for example, if it detects a paging from the network indicating an arrival of a DL data and/or if the WTRU sends (e.g., needs to send) UL data. Switching the WTRU from IDLE to CONNECTED may involve Core Network (CN) signaling, for example, as the WTRU's context may be released from the CN upon transitioning to IDLE.

During connection setup the WTRU may perform a random access (RA) procedure (e.g., also referred to as Random Access Channel, RACH, procedure herein), for example, before sending a setup request (e.g., RRCSetupRequest) or a resume request (e.g., RRCResumeRequest) message. The RA procedure may serve one or more of the following purposes: get UL synchronization between the WTRU and the network (e.g., gNB); obtain the resources that are to be used for the sending of the request message; etc.

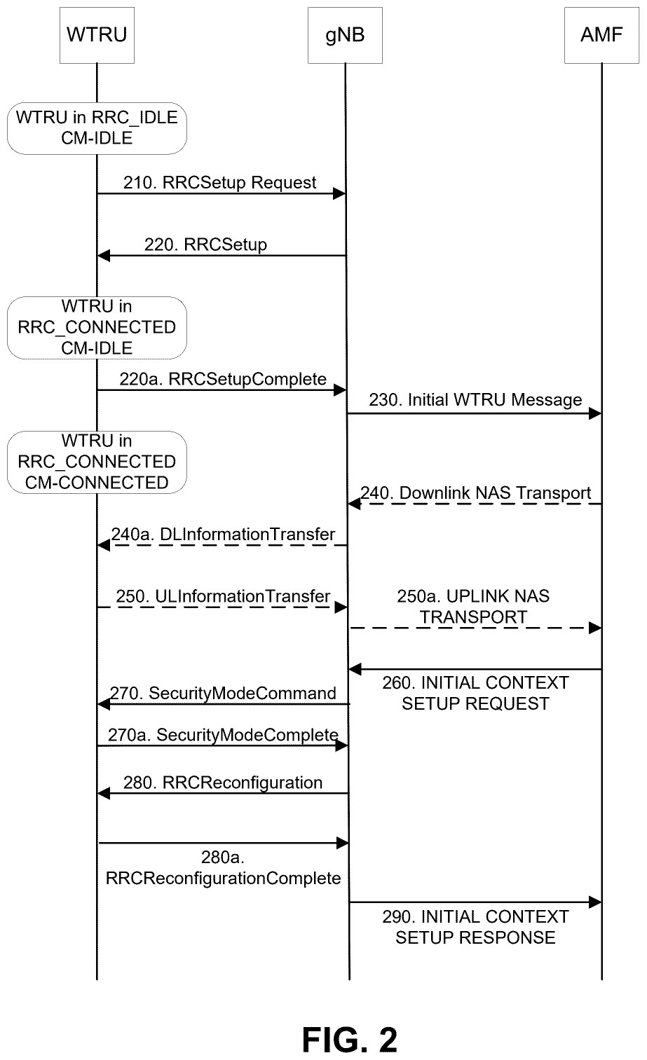

FIG. 2 illustrates an example RRC connection establishment/setup. RRC connection establishment/setup may include an RA procedure (e.g., omitted from FIG. 2 for sake of brevity).

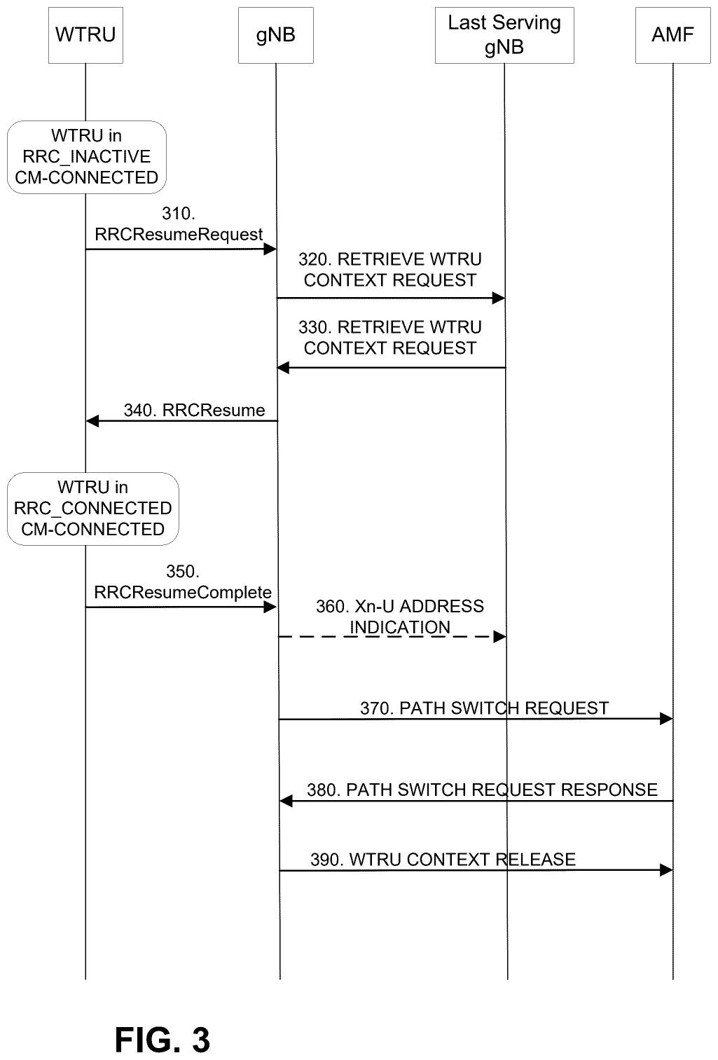

The transition from IDLE to CONNECTED may involve (e.g., a lot of) signaling overhead (e.g., as shown in FIGS. 2 and 3). When the WTRU goes to IDLE mode, the WTRU's RRC context may be released. The WTRU may not be known at the RAN level, and the RAN may receive (e.g., need to get) the WTRU context from the CN. Security may (e.g., need to) be re-established after that and the WTRU may be reconfigured with the DRBs and SRBs, for example, before UL/DL data transmission/reception could occur.

The RRC_INACTIVE state may mitigate this issue. In RRC_INACTIVE, the WTRU's context may be maintained at the CN. The WTRU may refrain from releasing (e.g., may not release) its context/configuration. The WTRU can be quickly brought up to the CONNECTED state, for example, without involving (e.g., the need to involve) the CN. WTRU may be fully re-configured (e.g., in CONNECTED state), which may reduce (e.g., greatly reduce) the latency required for the state transition and also reduce the signaling overhead in the network. FIG. 3 illustrates an example state transition between INACTIVE and CONNECTED states. If the WTRU resumes within the cells that belong to the same gNB as where it went to INACTIVE, the CN may not need to be involved at all.

The INACTIVE state may provide (e.g., as described herein) the power saving state of the IDLE state (e.g., without the drawback of high latency for transitioning to the CONNECTED state) as the WTRU context may be known at RAN level and CN may not have to be involved.

The transitioning from INACTIVE to CONNECTED may involves signaling overhead (e.g., at the RRC level). The processing delay for RRC resume can be up to 16 ms (e.g., the WTRU can be scheduled (e.g., only) after 16 ms after the WTRU has reception of the RRC resume message).

The gNB architecture may be include (e.g., be associated with) a centralized unit (CU)/decentralized unit (DU) split (e.g., RRC/PDCP terminated at the CU, while lower layers terminated at the DU). The Resume procedure may involve the signaling between the CU and DU over an interface (e.g., the F1 interface). The WTRU may use (e.g., require) signaling (e.g., RRC signaling) and/or the involvement of the CU-DU interface, for example, even if the WTRU resumes the connection within a cell belonging to the same DU (e.g., even to the very same cell) as when it was last in CONNECTED state.

Other split architecture examples are described (e.g., such as open Radio Access Network, for example, where the base station (gNB) may be realized via a CU, a DU and a radio unit (RU)). An RU may handle processing (e.g., all or some of the PHY layer processing). The DU may take care of functionalities (e.g., MAC and RLC functionalities (e.g., and some PHY functionalities, for example, if the RU is not handling all the PHY layer functionalities). In such architectures, the transition from INACTIVE to CONNECTED may use (e.g., will require) signaling over the RU-DU and the DU-CU interfaces, for example, even if the WTRU is resuming under the same RU where it was sent to INACTIVE state.

Latency, signaling, and/or processing used (e.g., required) to transition the WTRU back and forth between a power saving and full power operating states may be reduced.

A WTRU may (e.g., be configured to) operate with an L1/L2 INACTIVE operation within the DU/RU, for example, while in an RRC CONNECTED state (e.g., at an RRC/CU level).

An RRC_CONNECTED WTRU may stop, relax, or reduce measurements and/or perform mobility using cell re-selection and may apply pre-configured RRC reconfigurations upon cell re-selection.

A WTRU may perform one or more of the following.

The WTRU may receive configuration information indicating one or more candidate cells (e.g., RRC reconfigurations (e.g., as in the case of LTM)), where the cells may be grouped into one or more candidate cell groups (e.g., a group may include the cells within the same DU, same RU, etc.) For example, the one ore more candidate cell groups may include a group of cells within a DU.

The WTRU may receive an indication from the network (e.g., L1/L2 indication from the DU). The indication may instruct the WTRU to transition to a lower layer inactive state.

The WTRU may start performing one or more of the following (e.g., based on receiving the indication from the WTRU): stop, relax, or reduce performing radio resource management (RRM)/radio link monitoring (RLM) measurements; stop, relax, or reduce monitoring of a PDCCH; monitor indications for UL/DL data arrival (e.g., paging monitoring with the C-RNTI, reception of MAC CE, etc.); start performing measurements for cell re-selection and perform cell re-selection upon the fulfillment of cell re-selection criteria (e.g., prioritize the cells within the same candidate cell group (e.g., apply offsets))

The WTRU may perform cell re-selection to a target cell (e.g., based on measurements, for example, measurements associated with cell re-selection). The WTRU may perform one or more of the following based on performing cell re-selection to a target cell. The WTRU may apply the saved configuration associated with the target cell (e.g., execute the conditional LTM configuration), for example, based on performing cell re-selection to a target cell. The WTRU may store the RRC complete message, for example, if the target cell belongs to the same cell group as the source cell. The WTRU may refrain from sending the RRC complete message, for example, if the target cell belongs to the same cell group as the source cell.

The WTRU may receive UL data. The WTRU may receive a paging indicating arrival of DL data. The WTRU may perform a cell re-selection to a target cell that belongs to a different cell group than the source cell. Upon the arrival of UL data, reception of a paging indicating arrival of DL data, or performing a cell re-selection to a target cell that belongs to a different cell group than the source cell, the WTRU may perform one or more of the following: send an indication to the network requesting a transition back to a lower layer active state (e.g., L1/L2 indication containing a cause value for the transition (e.g., cell re-selection from the first cell group to the second cell group), e.g., UL data, DL data, sending of a HO complete message, etc.); receive an indication confirming a transition to the lower layer active state; transition to the L2 active (e.g., lower layer active) state (e.g., and perform one or more of: sending (e.g., any) pending HO complete message(s), sending UL data, receiving DL data, start performing RRM/RLM measurements and PDCCH monitoring as in legacy); send an indication to a network node indicating that the WTRU is connected to the target cell; etc.

The WTRU may transition (e.g., be enabled to transition) back and forth between a full power operating mode and a power saving mode, for example, with minimal signaling overhead and low latency. The WTRU can be put into the power saving state more frequently/longer, for example, reducing WTRU energy/battery consumption.

The terms indication, information and message may be used interchangeably.

The terms “current cell”, “serving cell”, “source cell”, and “current camping cell” may be used interchangeably.

The terms “target cell”, “candidate cell”, and “neighbor cell” may be used interchangeably.

The terms “mode” and “state” may be used interchangeably (e.g., INACTIVE mode, INACTIVE state)

The terms RRC_CONNECTED and CONNECTED may be used interchangeably

The terms RRC_IDLE and IDLE may be used interchangeably

The terms RRC_INACTIVE and INACTIVE may be used interchangeably.

The term Lower Layer Inactive or “LL_INACTIVE” state/mode may be used to refer to the WTRU state (e.g., described herein) where the WTRU may act like an INACTIVE WTRU from lower layer's point of view, while it is still in RRC_CONNECTED from the RRC point of view. In the case of split architecture with CU/DU split, this may include that the WTRU is in RRC_CONNECTED from the CU's point of view, but in LL_INACTIVE from the DU's point of view.

The term LL_CONNECTED or LL_ACTIVE may refer to the case where the WTRU is not in LL_INACTIVE (e.g., legacy case of operation in RRC_CONNECTED but seen from the lower layer's point of view.

The term “CU”, gNB, and “base station” may be used interchangeably.

For a WTRU in the LL_ACTIVE state, the term “cell switching” and “handover” may be used interchangeably.

For a WTRU in the LL_INACTIVE state, the term “cell switching” and “cell reselection” may be used interchangeably.

The terms “L1/L2 paging”, “LL paging”, “DU paging”, and “RU paging” may be used interchangeably, for example, to refer to a paging that is generated by the DU or RU to signal to the WTRU that a DL data is available to it and it should transition to the LL_CONNECTED state.

An LTM configuration that is applicable in the LL_INACTIVE state may include the configuration that the WTRU may apply/execute that LTM configuration, for example, based on performing cell-reselection towards cell.

An LTM configuration that is applicable in the LL_CONNECTED state may include the LTM configuration the WTRU may apply, for example, based on performing a handover to that cell (e.g., reception of an LTM MAC CE, conditional LTM, etc.)

The terms “configuration” and “reconfiguration” may be used interchangeably.

The term “HO complete message”, “LTM complete message”, “RRC reconfiguration complete message”, or simply “complete message” may refer to the RRC reconfiguration message that is sent from the WTRU to the network (e.g., target cell) after the WTRU has properly executed a HO/LTM/CHO.

Split architectures may be used and/or described herein.

Split architectures may be used for a protocol split among a centralized unit (CU) and a distributed unit (DU). Split architectures associated with a protocol split among a CU and a DU may include one or more options (e.g., as described herein). For example, for option 2, the RRC/PDCP may reside in the CU while the rest of the protocol stack is terminated at the DU. For example, for option 4, RRC/PDCP/RLC may be terminated at the CU while the rest of the protocol stack is terminated at the DU, and so on.

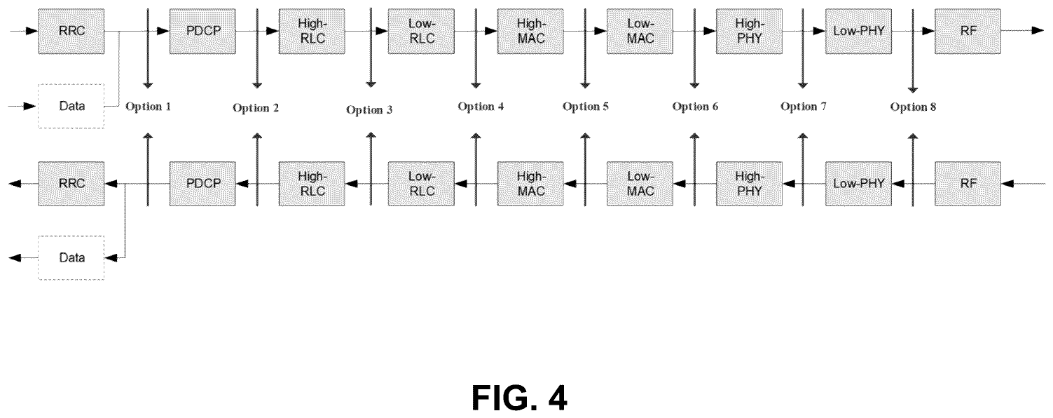

FIG. 4 illustrates example options for functional/protocol split between CU and DU.

Option 2 (e.g., RRC/PDCP terminated at the CU, the rest of the protocol layers terminated at the DU) may be used as the split architecture (e.g., for NR).

Other examples (e.g., such as those used with open RAN (O-RAN) may include further splitting options. For example, instead of a CU-DU split, the architecture could be CU-DU-RU, for example, where the RRC/PDCP may be terminated in the CU (e.g., as in NR), where the DU terminates the RLC/MAC and some functionalities of PHY (e.g., aspect that are more latency tolerant), and an RU that may terminates the lower parts of PHY (e.g., aspects that are time sensitive).

Split architecture options may be invisible from the WTRU's point of view (e.g., the WTRU may not even need to be aware whether the gNB that is serving it is a standalone gNB that terminates everything, a CU/DU unit, a CU/DU/RU unit and so on).

Details associated with INACTIVE state (e.g., RRC_INACTIVE state) may be described herein.

In RRC_INACTIVE, the WTRU's context may be maintained at the CN. The WTRU may refrain from releasing (e.g., may not release) its context/configuration.

During the RA procedures, the WTRU may send a message on the RACH (e.g., referred to as msg1) that may include a Preamble and/or a Random Access Radio Network Temporari Identifier (RA-RNTI) to the gNB. In the case of contention based random access (CBRA), the preamble may be selected (e.g., randomly selected) out of (e.g., a set of possible) preamble values (e.g., there could be a contention if another WTRU initiates a random access procedure using the same preamble value). In the case of contention free random access (CFRA), a specific preamble may be provided to the WTRU beforehand (e.g., when the WTRU was in CONNECTED state, during the transition to the IDLE/INACTIVE state, etc.). The RA-RNTI may be calculated based on the physical RACH (PRACH) occasion at which the random access message may be sent to the network.

The gNB (e.g., based on receiving msg1) may responds with msg2, for example, that may include a Random Access Response (RAR). For the WTRU to get the RAR, the network may send a DCI (Downlink Control Indicator) in the PDCCH that is scrambled with the RA-RNTI. The RA-RNTI may be used by the WTRU to determine on which resources (e.g., time and frequency) that RAR and other related information may provided to the WTRU. The WTRU may detect (e.g., try to detect) this DCI within a period of time after sending the preamble (e.g., the RAR-window). If such DCI is not received, the WTRU may retransmit the preamble again. If the DCI is received, the WTRU may get the RAR at the indicated time and frequency resources in the PDSCH. In the RAR and associated information, the WTRU may be provided with the timing advance (TA) to apply for sending UL data, the TC-RNTI (temporary Cell RNTI), and the UL resources to send the setup/resume request message.

The WTRU may get the detailed information/configuration regarding the usage of the random access channel (e.g., such as the RACH occasion), random access response window, etc., via configuration information (e.g., dedicated configuration information) while in CONNECTED state, upon transitioning during an IDLE/INACTIVE state, or from system information broadcast (SIB).

The network may include in a message (e.g., the RRCRelease message) an indication/information (e.g., suspendConfig), for example, if (e.g., when) the WTRU is sent to INACTIVE state. The SuspendConfig may include information such as, for example one or more of the following. The SuspendConfig may include information such as the resumeldentity to be used by the WTRU upon connection resume (e.g., to be included in the RRCResumeRequest message). The SuspendConfig may include information such as the RAN paging area (e.g., list of cells). The RAN paging area may include the RAN area where the WTRU can be paged at RAN level. If the WTRU performs cell re-selection to a cell outside the RAN area, the WTRU may perform an RAN area update procedure. The WTRU may also be configured to send a RAN area update procedure periodically. The SuspendConfig may include information such as a nextHopChaining count. The nextHopChaining count may be used for deriving the security context (e.g., encryption/integrity protection keys) upon resuming the connection.

When the WTRU performs the connection setup/establishment or resume procedure, the WTRU may include (e.g., in the RRCSetupRequest or RRCResumeRequest) the establishment or resume cause, respectively. Table 1 illustrates an example EstablishmentCause and an example ResumeCause.

TABLE 1

| | |
|---|---|
| EstablishmentCause ::= | ENUMERATED { |
| | emergency, highPriorityAccess, mt-Access, mo-Signalling, |
| | mo-Data, mo-VoiceCall, mo-VideoCall, mo-SMS, |
| | mps-PriorityAccess, mcs-PriorityAccess,spare6, spare5, |
| | spare4, spare3, spare2, spare1} |
| ResumeCause ::= | ENUMERATED {emergency, highPriorityAccess, mt-Access, mo-Signalling, |
| | mo-Data, mo-VoiceCall, mo-VideoCall, mo-SMS, rna-Update, |
| | mps-PriorityAccess,mcs-PriorityAccess, |
| | spare1, spare2, spare3, spare4, spare5 } |

The WTRU may set the establishment/resume cause to mobile originated voice call (mo-VoiceCall) or mobile originated video call (mo-VideoCall), for example, if the connection is being setup/resume due to a voice call or video call originating from the WTRU. The WTRU may set the establishment/resume cause to one of mobile terminated access (mt-Access), highPriorityAccess, mps-PriorityAccess, or mcs-PriorityAccess (e.g., depending on the access category of the WTRU), for example, if the connection is being setup/resumed due to downlink paging indicating DL data.

The mechanism used for RAN area update may be referred to as a “2 step resume” procedure, for example, because the WTRU may send a ResumeRequest indicating a cell re-selection outside the RAN area and the network may respond with a Release message (e.g., including a new RAN area configuration). The WTRU may remain in INACTIVE state, and the network may have information in which RAN area the WTRU can be accessible, for example, if there is a need to page the WTRU (e.g., arrival of DL data at the RAN that is intended for the WTRU).

Cell selection and re-selection may be performed and/or described herein.

On transition from RRC_CONNECTED to RRC_INACTIVE or RRC_IDLE, a WTRU may camp on a cell, for example, as result of cell selection according to the frequency be assigned by RRC in the state transition message (e.g., if any).

The cell selection criterion (e.g., criterion S) may be fulfilled by Srxlev>0 and Squal>0. In examples Srxlev may equal Qrxlevmeas-offset_1. In examples, Squal may equal Qqualmeas-offset_2. In examples, Srxlev may include the cell selection RX level value (e.g., in dB). In examples Squal may include the cell selection quality value (e.g., in dB). In examples, Offset_1 may include the offset to be applied on top of a cell's RSRP level (e.g., the sum of multiple offsets). In examples, Offset_2 may include the offset to be applied on top of a cell's RSRQ level (e.g., the sum of multiple offsets).

The WTRU may perform measurements and determinations for cell re-selection, for example, once a cell is selected for camping.

The WTRU may camp on (e.g., try to camp on) a cell operating with the highest priority RAT and with the highest priority frequency.

The WTRU may choose not to perform intra-frequency measurements, for example, if the serving cell fulfils Srxlev>SintraSearchP and Squal>SintraSearchQ. Otherwise, the WTRU may perform intra-frequency measurements.

The WTRU may choose not to perform measurements of NR inter-frequency cells of equal or lower priority, or inter-RAT frequency cells of lower priority, for example, if the serving cell fulfils Srxlev>SnonIntraSearchP and Squal>SnonIntraSearchQ. Otherwise, the WTRU may perform measurements of inter-frequency cells (e.g., NR inter-frequency cells) of equal or lower priority, or inter-RAT frequency cells of lower priority

SIntraSearchP may specify the Srxlev threshold (e.g., in dB) for intra-frequency measurements.

SIntraSearchQ may specify the Squal threshold (e.g., in dB) for intra-frequency measurements.

SnonIntraSearchP may specify the Srxlev threshold (e.g., in dB) for NR inter-frequency and inter-RAT measurements.

SnonIntraSearchQ may specify the Squal threshold (e.g., in dB) for NR inter-frequency and inter-RAT measurements.

The WTRU may perform cell rankings of cells, for example, if (e.g., when) the WTRU decides to perform intra-frequency measurements for cell re-selection based on the criteria (e.g., as described herein). Inter-frequency and inter-RAT reselection may be based on priorities (e.g., absolute priorities), for example, where a WTRU may camp (e.g., try to camp) on the highest priority frequency available.

The cell-ranking criterion (e.g., Criteria R) for serving cell (Rs) and for neighboring cells (Rn) may be represented in Eqs. 1 and 2.

$$Rs = Qmeas , s + Qhyst - Qoffsettemp \qquad Eq . 1$$

$$Rn = Qmeas , n - Qoffset - Qoffsettemp \qquad Eq . 2$$

For example, Qmeas may include the RSRP measurement quantity used in cell reselections. For intra-frequency, Qoffset may be Qoffsets, n, for example, if Qoffsets, n is valid and otherwise may equal zero. For inter-frequency Qoffset may be Qoffsets, n plus Qoffsetfrequency, for example, if Qoffsets,n is valid, and otherwise may equal Qoffsetfrequency. Qoffsettemp may include the offset temporarily applied to a cell.

The WTRU may rank cells (e.g., all cells) that fulfil the cell selection criterion S.

The cells may be ranked according to the R criteria (e.g., described herein), for example, by deriving Qmeas,n and Qmeas,s and calculating the R values using averaged RSRP results.

If rangeToBestCell is not configured, the WTRU may perform cell reselection to the highest ranked cell. If rangeToBestCell is configured, then the WTRU may perform cell reselection to the cell with the highest number of beams above the threshold (e.g., absThreshSS-BlocksConsolidation) among the cells whose R value is within rangeToBestCell of the R value of the highest ranked cell. If there are multiple such cells, the WTRU may perform cell reselection to the highest ranked cell among them.

The WTRU may reselect the cell, for example, based on one or more conditions (e.g., only if one or more of the following conditions are met). The WTRU may reselect the cell, for example, if a target cell (e.g., different/new cell) is better than the serving cell according to the cell reselection criteria specified above during a time interval TreselectionRAT. The WTRU may reselect the cell, for example, if more than one (1) second has elapsed since the WTRU camped on the current serving cell.

Handover may be performed and/or described herein.

A WTRU in CONNECTED mode (e.g., RRC_CONNECTED state) may be configured for Radio Resource Management (RRM) measurement configuration (e.g., to measure certain cells, frequencies, etc.). The WTRU may send a measurement report periodically or based on the fulfillment of an event (e.g., A3 event, when the signal from a neighbor cell to the WTRU has a signal strength stronger than that from the serving cell by more than a certain threshold).

The network (e.g., typically based on the RRM measurement reports) may decide to handover (HO) the WTRU to one of the neighbor cells. However, the HO may be decided by the network without reception of a measurement report. HO may be performed due to load balancing or energy saving purposes (e.g., independent of radio signal levels, not necessarily due to radio signal levels).

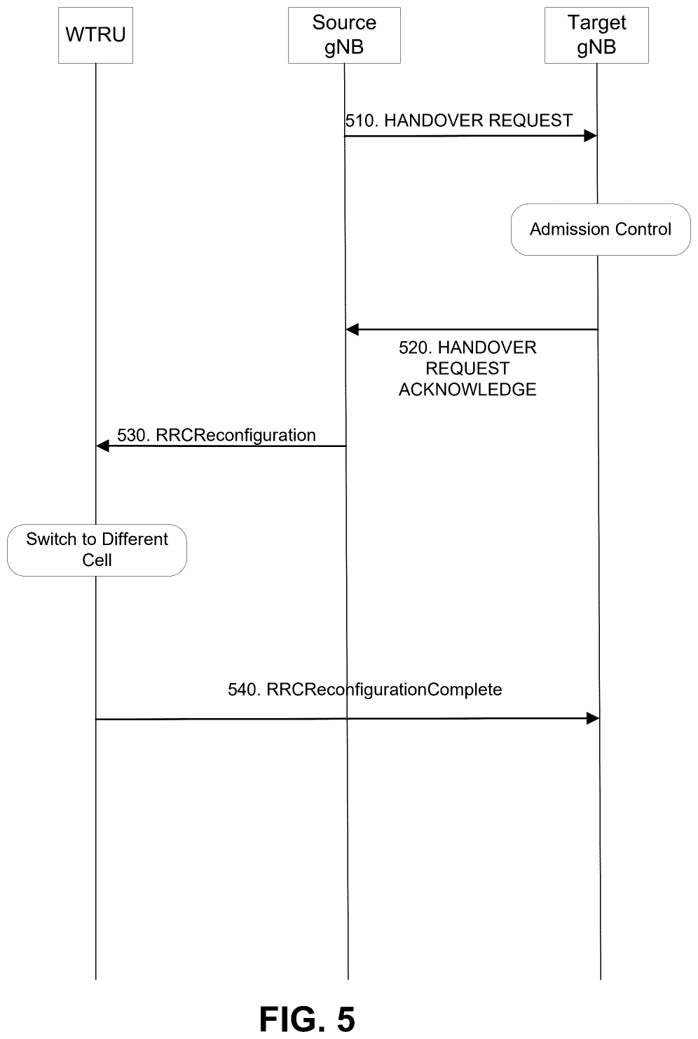

FIG. 5 illustrates an example handover procedure.

As shown at 510 in FIG. 5, the source gNB may initiate a handover and may issue a HANDOVER REQUEST over the interface (e.g., Xn interface).

As shown at 520 in FIG. 5, the target gNB may perform admission control and provides the RRC configuration as part of the HANDOVER REQUEST ACKNOWLEDGE.

As shown at 530 in FIG. 5, the source gNB may provide the RRC configuration to the WTRU by forwarding the RRCReconfiguration message received in the HANDOVER REQUEST ACKNOWLEDGE. The RRCReconfiguration message may include at least a cell ID and information (e.g., all information) used (e.g., required) to access the target cell so that the WTRU can access the target cell without reading system information. For some cases, the information used (e.g., required) for contention-based and contention-free random access may be included in the RRCReconfiguration message. The RRCReconfiguration that is used for handover purposes may be referred to as the HO Command.

As shown at 540 in FIG. 5, the WTRU may move the RRC connection to the target gNB and may reply with the RRCReconfigurationComplete (e.g., a HO Complete message).

Conditional Handover (CHO) may be performed and/or described. CHO may be an enhancement of the HO procedure, for example, where the WTRU is initially prepared/configured with a HO command towards a target and associated radio conditions when the Ho command is to be executed. The WTRU (e.g., instead of executing the HO command immediately) may monitor the triggering conditions (e.g., if the target cell's radio signal level becomes better than the serving cell's by more than a threshold). The WTRU may execute the HO command based on the condition being fulfilled (e.g., only when the condition is fulfilled). The CHO command could be sent when the radio conditions towards the current serving cells are still favorable, for example, reducing the two main points of failure in legacy handover (e.g., risk failing to send the measurement report (e.g., if the link quality to the current serving cell falls below acceptable levels when the measurement reports are triggered in normal handover) and the failure to receive the handover command (e.g. if the link quality to the current serving cell falls below acceptable levels after the WTRU has sent the measurement report, but before it has received the HO command)).

L1/L2 triggered mobility may be performed and/or described herein.

L1/L2 triggered mobility (LTM) may include where the WTRU is pre-configured (e.g., like in the case of CHO) with RRC reconfiguration to apply upon switching (e.g., being handed over) from a source cell to a target cell, for example, where the switching/handover may be based on receiving a signaling (e.g., MAC CE) indicating the cell switch (e.g., instead of autonomous handover in the case of CHO based on the fulfillment of measurement events). LTM may improvement handover latency and interruption time, for example, compared to Layer 3 based mobility.

In LTM, the gNB may receive L1 measurement report(s) from a WTRU. The gNB may on the basis of the L1 measurement report(s) change the WTRU serving cell by a cell switch command (e.g., signaled via a MAC CE). The cell switch command may indicates the identity of the cell (e.g., among the cells in the LTM configuration) and the WTRU may execute the corresponding RRC reconfiguration.

Initiating UL timing advance (TA) acquisition (e.g., early TA) procedure of one or multiple cells that are different from the current serving cells may be enabled, for example, if (e.g., when) configured by the network. The network may request the WTRU to perform early TA acquisition of a candidate cell before a cell switch (e.g., via a PDCCH order). Early TA acquisition of the candidate cell before the cell switch may be realized through WTRU-based TA measurement/calculation (e.g., if WTRU is capable of that). In the former case, the gNB/gNB-DU to which the candidate cell belongs may calculate the TA value and may send it to the gNB/gNB-DU to which the serving cell belongs (e.g., via gNB-CU). The serving cell may send the TA value in the LTM cell switch command (e.g., via MAC CE), for example, if (e.g., when) triggering LTM cell switch. In the latter case, the WTRU may perform TA measurement/calculation for the candidate cells after being configured by RRC (e.g., but the exact time the WTRU performs TA measurement may be up to WTRU implementation). The WTRU may apply the TA value measured by itself and performs RACH-less LTM, for example, based on receiving the cell switch command. The network may send a TA value in the LTM cell switch command (e.g., via MAC CE) without early TA acquisition.

The WTRU may perform either a RACH-less LTM or RACH-based LTM cell switch, for example, depending on the availability of a valid TA value. If the valid TA value is provided in the cell switch command, the WTRU may apply the TA value as instructed by the network. In the case where WTRU-based TA measurement is configured, but no valid TA value is provided in the cell switch command, the WTRU may apply the valid TA value by itself (e.g., if available). The WTRU may perform RACH-less LTM cell switch, for example, based on receiving the cell switch command. If no valid TA value is available, the WTRU may perform a RACH-based LTM cell switch.

The WTRU may monitor (e.g., start to monitor) PDCCH on the target cell for dynamic scheduling, for example, based on an initiation of LTM cell switch to the target cell. Before a RACH-less LTM procedure completion, the WTRU may refrain from triggering (e.g., not trigger) random access procedure, for example, if the WTRU does not have a valid PUCCH resource for triggered SRs.

The RRC reconfiguration message to apply upon LTM may be a full RRC reconfiguration (e.g., to completely replace the RRC configuration that was used at the source cell) or a delta RRC configuration (e.g., to be applied on top of the current RRC configuration used at the source). The WTRU may be provided with an LTM reference configuration that is common to LTM candidate cells (e.g., all or a subset of LTM candidate cells), and individual configurations that may be relevant to each (e.g., a) candidate cell (e.g., only to each candidate cell). The WTRU may apply the reference configuration (e.g., followed by the individual configuration that is associated to the cell the WTRU is switching to), for example, based on switching to a candidate cell due to LTM. There could be an (e.g., one) individual configuration for a given target cell or there could be multiple configurations for a given target cell. For example, for target cell X, there could be several individual LTM configurations, the first one to be applied when switching from cell A to cell X, the second one when switching from cell B to cell X, the third one when switching from cell C to cell X and so on.

Conditional LTM may be used. Conditional LTM may be similar to CHO but using the LTM configuration instead (e.g., WTRU executing LTM based on L1/L3 measurement events without waiting for the LTM MAC CE).

WTRU configurations may relate to LL_INACTIVE operations. WTRU configurations related to LL_INACTIVE operations may be used and/or described herein.

The WTRU may receive configuration information (e.g., a configuration) that includes a list of cells (e.g., target cells) and corresponding configuration(s) (e.g., RRC reconfiguration(s)) that may be applicable for the WTRU's operation in LL_INACTIVE state.

In examples, the configuration can be the same as an LTM configuration.

In examples, the WTRU may receive an indication of a grouping of the candidate cells (e.g., cells 1, 2, 3 belong to group A, cells 4,5 to group B, etc.). The WTRU may be configured to behave differently (e.g., while in the LL_INACTIVE state) when switching between the cells within a group as compared to when switching between cells outside the same group (e.g., as described herein). The cells within the same group may be referred to belonging to the same LL_INACTIVE cell group/area.

In examples, the cells within an LL_INACTIVE cell group may belong to the same DU/RU.

In examples, the cells within an LL_INACTIVE cell group may belong to more than one DU/RU.

In examples, there could be several LL_INACTIVE cell groups for a given DU/RU.

In examples, a (e.g., one) target cell belongs to an (e.g., only one) LL_INACTIVE cell group.

In examples, a (e.g., one) target cell may belong to multiple LL_INACTIVE cell groups.

In examples, the different LL_INACTIVE cell groups may have associated cell grouping IDs.

In examples, an additional IE/parameter may be introduced in the (e.g., legacy) LTM configurations (e.g., LL_INACTIVE cell group ID, that indicates the LL_INACTIVE group that the cell belongs to, or a list of IDs, if a cell can belong to multiple groups).

In examples, the WTRU may be configured with a mapping of the candidate cell IDs to LL_INACTIVE cell groups (e.g., where the LTM configurations may be as in legacy). For example, the WTRU may receive configuration information (e.g., an RRC reconfiguration) that includes a ToAddModList/ToReleaseList IEs that may add/remove cells to an LL_INACTIVE cell group.

In examples, the LTM configuration (e.g., for all candidates, for all candidates within a candidate cell grouping, for a subset of candidate cells, for a particular candidate cell, etc.,) may be applicable (e.g., equally applicable) while the WTRU is in LL_CONNECTED and LL_INACTIVE.

In examples, the WTRU may be provided with a first LTM configuration (e.g., for all candidates, for all candidates within a candidate cell grouping, for a subset of candidate cells, for a particular candidate cell, etc.), that may be applicable to LL_CONNECTED and another (e.g., second) LTM configuration that may be applicable for LL_INACTIVE.

In examples, the WTRU may have the same LTM reference configuration for both LL_CONNECTED and LL_INACTIVE but may have different individual configurations for LL_CONNECTED and LL_INACTIVE. For example, the WTRU may have a reference configuration that is applicable to cell group A (e.g., containing cells 1, 2, and 3) that is applicable to both LL_CONNECTED and LL_INACTIVE, but two pairs of individual (e.g., delta) configurations for each of the cells 1, 2 and 3, for example, where the first one of the pair may be applicable to LL_CONNECTED and the second one for LL_INACTIVE.

In examples, the WTRU may have different LTM reference configurations for LL_CONNECTED and LL_INACTIVE but the same individual configurations for both LL_CONNECTED and LL_INACTIVE. For example, the WTRU may have a first reference configuration that is applicable to cell group A (e.g., containing cells 1, 2, and 3) that may be applicable to LL_CONNECTED, and a second reference configuration that may be applicable to LL_INACTIVE, for example, but just a (e.g., one) individual (e.g., delta) configuration for each of the cells 1, 2 and 3.

In examples, the WTRU may have the same LTM reference configuration (e.g., for a given grouping of cells) for both LL_CONNECTED and LL_INACTIVE but some of the information elements/parameters may be applicable to (e.g., applicable only to) the LL_CONNECTED state, some applicable only to the LL_INACTIVE state, and the rest applicable to both states.

In examples, the WTRU may have the same individual LTM configuration for a given target cell (e.g., to be applied on top of a reference configuration, to be applied by itself without a reference configuration, etc.,) for both LL_CONNECTED and LL_INACTIVE but some of the information elements/parameters may be applicable to (e.g., applicable only to) the LL_CONNECTED state, some applicable only to the LL_INACTIVE state, and the rest applicable to both states.

In examples, the WTRU may be provided with information (e.g., configuration information) related to cell switching/re-selection while in the LL_INACTIVE state. For example, the WTRU may be configured to get this information from a system information broadcast (SIB) (e.g., SIB2, SIB3, SIB4). In another example, the WTRU may be configured with cell (re-) selection parameters in a dedicated manner (e.g., in RRC reconfiguration message before transitioning to the LL_INACTIVE state, for example, based on transitioning to the LL_INACTIVE state). In another example, the WTRU may be configured with some of the cell-reselection parameters in the SIB and others in a dedicated message.

Transitioning to the LL_INACTIVE state may be performed and/or described herein.

In examples, the WTRU may transition to the LL_INACTIVE state, for example, based on the reception of an indication from the network (e.g., CU, DU, RU, etc.).

In examples, the indication may be an RRCRelease like message. For example, this RRC message may have been generated by the CU, stored at the DU/RU, and/or transmitted to the WTRU (e.g., when the DU/RU decides to transition the WTRU to LL_INACTIVE). In examples, the indication may include a signaling, such as, for example, a MAC CE. In examples, the indication may include a L1 signal (e.g., like a DCI).

In examples, the WTRU may transition to the LL_INACTIVE state based on a determination of inactivity (e.g., in the UL, DL, or both). The WTRU may be configured with an inactivity time duration threshold. The WTRU may transition to the LL_INACTIVE state, for example, if it determines that the WTRU has no UL/DL transmission/reception during that time (e.g., the inactivity time duration threshold). There could be a (e.g., one) inactivity time duration threshold that is used to monitor both UL and DL activity. The WTRU can be configured with different thresholds (e.g., first threshold and second threshold) for the monitoring of UL and DL data activity (e.g., first threshold for UL data activity, and second threshold for DL data activity).

In examples, the WTRU (e.g., based on transitioning to the LL_INACTIVE state based on inactivity determination) may send an indication to the network (e.g., a MAC CE, a UCI, a particular scheduling request (SR) if the WTRU doesn't have the UL grants available to send the MAC CE or UCI, etc.).

In examples, the WTRU may transition to the LL_INACTIVE state based on or aligned with a DRX configuration. For example, the WTRU may transition to LL_INACTIVE state during the “OFF duration” of the DRX cycle.

Behavior during the LL_IINACTIVE state may be described herein.

In examples, the WTRU may be configured to perform mobility according to the RRC_IDLE/RRC_INACTIVE case (e.g., based on cell re-selection), for example, instead of RRC_CONNECTED state mobility.

In examples, the WTRU may read (e.g., start reading) the system information broadcast to get information related to cell re-selection (e.g., SIB2, SIB3, SIB4, etc.). In examples, the WTRU may use cell re-selection parameters (e.g., it was configured with), for example, while in LL_CONNECTED or based on transitioning to LL_INACTIVE. A combination of both may be performed (e.g., may be feasible), for example, by using some parameters from the broadcast and/or some from the dedicated configuration. In examples, if a certain parameter is configured by both broadcast or dedicated messaging, the WTRU may be configured to use the parameter value indicated in the dedicated message. In another example, the WTRU is configured to use the parameters in the broadcast message.

In examples, the WTRU may be configured to select the current serving cell as the “camping” cell, for example, based on transitioning to the LL_INACTIVE state (e.g., cell selection procedure that is triggered in legacy upon transitioning to RRC_IDLE and RRC_INACTIVE not triggered, but WTRU will start performing the cell re-selection measurements/procedures).

In examples, the WTRU may be configured to perform a cell selection procedure, for example, based on transitioning to the LL_INACTIVE state (e.g., as in legacy transition to RRC_IDLE and RRC_INACTIVE). The WTRU may perform actions (e.g., as described herein) upon changing cells while in the LL_INACTIVE state, for example, if the WTRU performing cell selection procedure results in selecting another cell than the current cell.

The WTRU may be configured to perform measurements (e.g., Radio Resource Management, RRM, measurements for L3 mobility, L1/L2 measurements for LTM mobility, L1 measurements for scheduling, Radio Link Monitoring, RLM, measurement for Radio Link Failure detection, etc.). The WTRU may be configured with associated measurement reporting differently while in LL_INACTIVE state (e.g., suspend performing the measurements, relax the performing of the measurements by decreasing the measurement periodicity, suspend the measurement reporting, etc.).

In examples, the WTRU may be configured to stop (e.g., reduce) PDCCH monitoring on the serving cell(s).

In examples, the WTRU may be configured to perform the PDCCH monitoring on the serving cell(s) in a relaxed (e.g., reduced) manner (e.g., longer periodicity).

In examples, the WTRU may be configured to monitor the PDCCH of the serving cell for a paging message, for example, to determine if there is a DL data pending for it at the DU/RU. The information on how to monitor the paging may be similar to the paging performed for RRC_INACTIVE or RRC_CONNECTED case (e.g., information about the paging occasions, WTRU paging identity, etc., may be provided to the WTRU in a dedicated message before transitioning or upon transitioning to the LL_INACTIVE state, or provided via system information broadcast). The paging configuration to be used for LL_INACTIVE may be the same or different from the one to be used for the RRC_INACTIVE/IDLE cases. For example, the WTRU may be configured with a different paging identity (e.g., use the C-RNTI as the paging identity, as the WTRU is already assigned a C-RNTI assigned to it since the WTRU is still in RRC_CONNECTED state).

In examples, the WTRU may receive the indication that a DL data is available by another means than a paging indication (e.g., via signaling, such as, for example, MAC CE, DCI, etc.).

Cell switching determination may be performed while in LL_INACTIVE.

In examples, the WTRU may be configured to use SintraSearchP and/or SintraSearchQ (e.g., the same SIntraSearchP and/or SintraSearchQ as in the RRC_IDLE/RRC_INACTIVE state) to determine whether it needs to perform intra-frequency neighbor cell measurements for cell re-selection while in LL_INACTIVE state.

In examples, the WTRU may be configured to use different SIntraSearchP and/or SintraSearchQ (e.g., as compared to the ones to be used in the RRC_IDLE/RRC_INACTIVE state) for cell re-selection while in LL_INACTIVE state. For example, this could be absolute values or relative values (e.g., as compared to the values used for the RRC_IDLE/RRC_INACTIVE state).

In examples, the WTRU may be configured to use the SnonIntraSearchP and/or SnonIntraSearchQ (e.g., same SnonIntraSearchP and/or SnonIntraSearchQ as in the RRC_IDLE/RRC_INACTIVE state) to determine whether it needs to perform inter-frequency neighbor cell measurements for cell re-selection while in LL_INACTIVE state.

In examples, the WTRU may be configured to use different SnonIntraSearchP and/or SnonIntraSearchQ (e.g., as compared to the ones to be used in the RRC_IDLE/RRC_INACTIVE state) for cell re-selection while in LL_INACTIVE state. For example, this could be absolute values or relative values (e.g., as compared to the values used for the RRC_IDLE/RRC_INACTIVE state).

In examples, the WTRU may be configured to prioritize cells within the same LL_INACTIVE cell group for cell re-selection. For example, the WTRU may be configured with a positive offset to apply on top of the signal levels of the cells belonging to the same LL_INACTIVE cell group as the current serving cell and/or a negative offset to apply on top of the signal levels of the cells not belonging to the same LL_INACTIVE cell group. The WTRU may perform the cell ranking and perform (e.g., decide to perform) a cell re-selection to the highest ranked cell (e.g., a cell belonging to the same group as the current cell or outside the group).

The WTRU may reselect to a target cell, for example, if (e.g., only if) the cell reselection criteria are met by the target cell for a TreselectionRAT duration and that it has been camped on the current cell by more than 1 second.

In examples, the WTRU may be configured to the same TreselectionRAT duration and 1 sec duration (e.g., as in legacy case) for RRC_IDLE/INACTIVE for determining whether it can reselect to another cell.

In examples, the WTRU may be configured with a different TreselectionRAT duration to use for the cell reselection determination in LL_INACTIVE (e.g., as compared to the RRC_IDLE/INACTIVE case).

In examples, the WTRU may be configured to stay at least a time duration of (e.g., minimum camping duration) at a cell before it can do a cell selection to another cell while in LL_INACTIVE. This time duration can be larger than or smaller than one (1) second (e.g., the one (1) second that the WTRU uses in RRC_IDLE/INACTIVE cases).

In examples, the WTRU may be configured with different TreselectionRAT to be used for a target that is within the same LL_INACTIVE cell group as the source.

In examples, the WTRU may be configured with different minimum camping duration time threshold to be used, for example, if the source and target are in the same LL_INACTIVE cell group as compared to the case where they are in the same group.

Actions may be performed, for example, based on cell switching while in LL_INACTIVE.

In examples, the WTRU (e.g., upon performing cell re-selection while in LL_INACTIVE) may execute the reconfiguration (e.g., LTM RRC reconfiguration) that is associated with the target cell. This may include (e.g., involve) executing one or more of executing the relevant LTM reference configurations (e.g., if any), followed by the individual LTM configuration associated with the target (e.g., and possibly with the source, for example, if there were several LTM configuration for a given target, each associated with a given target).

Switching within the same LL_INACTIVE cell group may be performed.

In examples, the WTRU may refrain from transmitting the HO complete message and instead stores it, for example, if the source and target cell belong to the same LL_INACTIVE cell group (e.g., based on a determination that the source and target cell belong to the same cell group).

In examples, the WTRU may be configured to delete the HO complete message (e.g., not send it, not generate it to begin with after executing the LTM reconfiguration, etc.)

In examples, the WTRU may store (e.g., keeps storing) each (e.g., each additional) HO complete message, for example, if the WTRU performs multiple switching between cells within the LL_INACTIVE cell groups. For example, if the WTRU transitioned while in cell A and then performed switching to cell B followed by cell C, where cells A, B and C belong to the same LL_INACTIVE cell group, the WTRU may store the two HO complete messages (e.g., corresponding to the switching from A to B and the second one corresponding to the switch form B to C).

In examples, the WTRU, may keep the latest HO complete message (e.g., just keep only the latest HO complete message), and the WTRU may delete the previous one. In the above example, at the first switching, the WTRU may store the complete message corresponding to the switching from A to B. At the second switching, the WTRU may delete the complete message it has already stored and stores the second (e.g., new) complete message corresponding to the switching from B to C, and so on.

In examples, if the WTRU is configured to keep more than one complete message, it may be configured to keep track of the time (e.g., absolute time, relative time form the time of transition to the LL_INACTIVE state, relative time from the previous switching while in LL_INACTIVE, etc.,) along with a (e.g., each) HO complete message.

In examples, if the WTRU switches from cell X to cell Y and subsequently from cell Y back to cell X, the WTRU may delete (e.g., may be configured to delete) the two HO complete messages corresponding to the cell switching (e.g., the WTRU has gone to where it was and as such the network may not need to be informed about this later, as described herein with respect to sending stored HO complete messages).

In examples, the WTRU may be configured to store a number (e.g., maximum number of HO complete messages). The WTRU may delete the oldest stored HO complete message to make room for the latest one. For example, this limit (e.g., maximum number) may be configured to be 2. If the WTRU switches from cell A to B to D to E and so on, the WTRU may have stored the following complete messages: after the first switching, a complete message corresponding to switching from A to B; after the second switching, a complete message corresponding to switching from A to B and a complete message corresponding to switching from B to C; after the third switching, a complete message corresponding to switching from A to B, a complete message corresponding to switching from B to C, and complete message corresponding to switching from C to D; after the fourth switching, a complete message corresponding to switching from B to C, a complete message corresponding to switching from C to D, and a complete message corresponding to switching from D to E; and so on.

In examples, the WTRU may be configured to store a HO complete message for a certain time duration. The WTRU may delete it after that time duration has elapsed. In examples, this may be applicable to a HO complete message (e.g., all the HO complete messages) except for the last one. In examples, this may be applicable to a HO complete message (e.g., all the HO complete messages) including the last one.

In examples, the WTRU may be configured with a threshold corresponding to a maximum number of cell switchings. The WTRU may transmit (e.g., trigger an action to transmit) the stored HO complete(s) (e.g., as described herein), for example, if this threshold has been passed (e.g., WTRU keeps a counter, the value of which is set to 0 at the transition to LL_INACTIVE, and incremented every time there is a switching within an LL_INACTIVE cell group).

In examples, the WTRU may be configured with a time duration threshold corresponding to a maximum time the WTRU may refrain from sending HO complete message(s) (e.g., and storing them instead). For example, the WTRU may start tracking a time (e.g., via a timer), with a duration (e.g., timer duration) equivalent to this time duration threshold. The WTRU may transmit (e.g., trigger an action to transmit) the stored HO complete message(s) (e.g., as described herein), for example, when this time duration elapses, if the WTRU has stored HO complete message(s).

A combination of the thresholds corresponding to the time and number of switchings may be used (e.g., feasible), for example, the transmission of the stored HO complete messages may be triggered if there are more than a certain number of HO complete messages stored with a given time duration.

In examples, the storing of multiple HO complete messages may include storing each individual HO complete message.

In examples, the storing of multiple HO complete message may include storing a summarized version of the individual HO complete message. For example, the WTRU may keep the last HO complete message but may keep track of the mobility history of the WTRU. For the example above where the WTRU has switched from cell A to B to C to D and then to E, the WTRU may be storing just one HO complete message (e.g., corresponding to the last switching from D to E), but may also include the switching history (e.g., in an ordered list of cell ID, where the cell IDs could be the cell ID corresponding to the LTM configurations, the PCI corresponding to the cells).

Switching to a cell belonging to a different LL_INACTIVE cell group may be performed.

The WTRU may be configured to transmit the HO complete message and any HO complete messages that were generated and stored (e.g., according to any of the examples described above due to a switching with the same LL_INACTIVE cell group), for example, if the source and target cell belong to different LL_INACTIVE cell group.

In examples, the WTRU may be configured with a time duration threshold (e.g., certain time duration threshold) to wait before transmitting the HO complete message (e.g., and any other stored complete messages) due the switching to a cell outside the LL_INACTIVE cell group of the source. The WTRU may refrain from transmitting (e.g., not transmit) the HO complete message and may keep it stored, for example, if the WTRU performs a switching back to one of the cells belonging to the previous LL_INACTIVE cell group before that time duration (e.g., t) has elapsed. The WTRU may transmit the HO complete (e.g., and any other stored complete messages), for example, if the time duration elapsed before that happens (e.g., before the WTRU performs a switching back to one of the cells belonging to the previous LL_INACTIVE cell group before that time duration has elapsed).

HO complete message(s) (e.g., stored HO complete message(s)) may be sent.

In addition to the conditions discussed above for triggering the transmission of HO complete messages (e.g., switching to a cell outside the LL_INACTIVE cell group, switching within the same LL_INACTIVE cell group but for more than the configured timed duration and/or the configured maximum switching threshold), the WTRU may be configured to trigger the transmission of the HO complete message(s), for example, based on the arrival of UL data or upon receiving a paging (e.g., DU paging) indicating the arrival of a DL data.

In examples, the WTRU may be configured to send the HO complete messages based on (e.g., only on) arrival of UL data or paging indicating DL data. The WTRU may send an indication (e.g., a L1/L2 indication) to the network (e.g., to the source cell immediately before the switching, to the target cell after switching) indicating that it is switching to another cell outside the current LL_INACTIVE cell group (e.g., including the target cell ID or/and LL_INACTIVE cell group ID), for example, based on performing a cell switching to a cell outside the LL_INACTIVE cell group. This way, if the LL_INACTIVE cell group was associated with the cells belonging to one DU, it may ensure that DL data may not be lost (e.g., the former DU serving the earlier LL_INACTIVE cell group, upon receiving a DL data for that WTRU, may inform the CU that the WTRU is no longer there and indicate the target (e.g., new) cell where the WTRU is located at and the CU may forward the data to the target DU instead, which can send a DU paging to the WTRU and deliver the data). For example, the WTRU (e.g., if it switches back to a cell belonging to the previous LL_INACTIVE cell group) may send a L1/L2 indication that it has returned to that cell group (e.g., previous UL-DL paths, from the CU's perspective can still be kept).

The source DU or target DU may (e.g., alternatively, immediately) inform the CU that the WTRU has changed to a cell belonging to another DU, for example, so that the CU may be up to date (e.g., always be up to date) regarding the DU serving the WTRU.

The WTRU may transition back to LL_CONNECTED.

The WTRU may be configured to transition back to the LL_CONNECTED state, for example, based on the detection of an UL data, receiving a DU paging message indicating a pending DL data for the WTRU, or upon performing some cell re-selection that triggers the sending of a HO complete message immediately (e.g., switching to a cell group outside the LL_INACTIVE cell group, etc.).

The WTRU may be configured to send an indication to the network that it wants to transition to LL_CONNECTED state.

The indication sent by the WTRU may be a L1/L2 indication (e.g., RACH pre-amble, a UCI, a MAC CE etc.). The indication may include information regarding the reason why the WTRU is transitioning to the LL_CONNECTED state (e.g., cause value indicating UL data has arrived, paging has been received, a HO complete message has to be sent to indicate switching to a cell outside the LL_INACTIVE cell group, etc.). The indication may be composed of multiple messages (e.g., a RACH pre-amble to get an UL sync, followed by a L1/L2 indication indicating the need for transition and the reason, etc.).

The WTRU may be configured to receive a response message (e.g., from the DU, RU, etc.,) to the indication it has sent. The response message (e.g., a L1/L2 message such as a MAC CE, a DCI, etc.,) may instruct the WTRU to transition to the LL_CONNECTED state. The response message may include additional information (e.g., information regarding UL resources/grants the WTRU can use to send the UL data or HO complete message, information regarding DL resources/grants the WTRU can use to receive the DL data, etc.). If the indication sent from the WTRU requesting the transition to LL_CONNECTED consists of several message, the response from the network may be also multiple messages (e.g., a RA response to a RACH indicating a time advance to be used by the WTRU during UL transmissions, L1/L2 indication indicating the WTRU that it can transition, etc.)

The response message from the network may include an indication indicating to the WTRU to remain in the LL_INACTIVE state. For example, the WTRU may have indicated that it is sending the indication just to inform the network that it has switched to a different LL_INACTIVE cell group. The network may respond (e.g., immediately respond), for example, by indicating to the WTRU to remain in LL_INACTIVE (e.g., the WTRU may send the stored HO complete message(s) later when it initiates a transition to LL_CONNECTED due to UL/DL data).

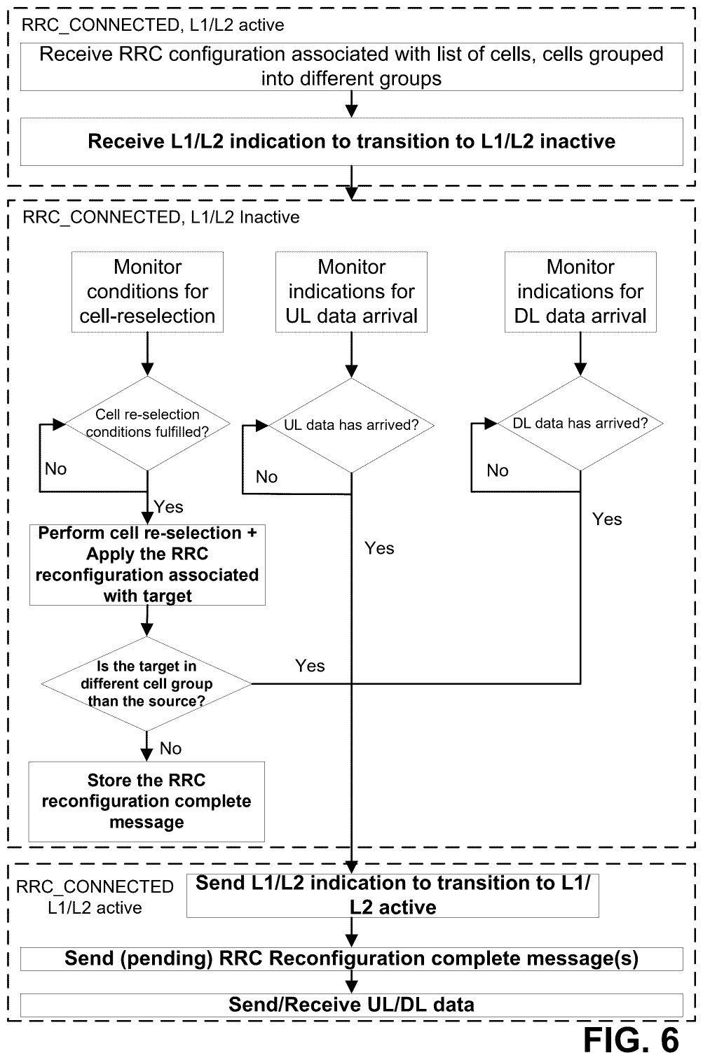

FIG. 6 illustrates an example flow of cell reselection and RRC complete message transmission and storage.

As shown in FIG. 6, the WTRU may receive configuration information (e.g., a configuration) of one or more candidate cells (e.g., RRC reconfigurations as in the case of LTM). The one or more candidate cells may be grouped into one or more cell groups.

As shown in FIG. 6, the WTRU may receives an indication (e.g., L1/L2 indication) from the network. The indication may instruct the WTRU to transition to a lower layer inactive state.

As shown in FIG. 6, the WTRU may (e.g., while in the lower layer inactive state) perform one or more of the following: perform mobility based on IDLE/INACTIVE state cell re-selection principles; monitor the arrival of DL data (e.g., paging); monitor the arrival of UL data (e.g., from higher layers); etc.

As shown in FIG. 6, the WTRU may (e.g., based on cell re-selection) perform one or more of the following: apply the saved configuration associated with the target cell (e.g., execute the conditional LTM configuration); store the RRC complete message if the target cell belongs to the same cell group as the source cell; etc.

As shown in FIG. 6, the WTRU may determine the arrival of UL data, reception of a paging indicating arrival of DL data, and/or perform a ce; re-selection to a target cell that belongs to a different cell group than the source cell. The WTRU may (e.g., based on the arrival of UL data, reception of a paging indicating arrival of DL data or performing a cell re-selection to a target cell that belongs to a different cell group than the source cell) send an indication to the network requesting a transition back to a lower layer active state (e.g., containing a cause value for the transition, e.g., UL data, DL data, sending of a HO complete message, etc.)

As shown in FIG. 6, the WTRU may transition to the L2 active state and perform one or more of the following: send a pending (e.g., any pending) HO complete message(s); send UL data; receive DL data; etc.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit and receive unit (WTRU) comprising:
a processor configured at least to:
receive from a network node an indication to transition to a lower layer inactive state;
transition to the lower layer inactive state;
perform measurements associated with cell re-selection;
on a condition, based on the measurements associated with cell re-selection, cell-reselection criteria are satisfied,
perform cell-reselection from a source cell to a target cell, and
apply a configuration associated with the target cell; and
on a condition that the source cell is associated with a first cell group that is different than a second cell group that the target cell is associated with,
send an indication to a network node indicating the WTRU is connected to the target cell.

2. The WTRU of claim 1, wherein the processor is further configured to:
on a condition that the source cell and the target cell are associated with a same cell group, store an RRC complete message.

3. The WTRU of claim 1, wherein the processor is further configured to:
on a condition that the source cell and the target cell are associated with a same cell group, refrain from sending an RRC complete message.

4. The WTRU of claim 1, wherein the processor is further configured to:
on a condition that the WTRU is in the lower layer inactive state,
reduce performing radio resource management (RRM) measurements and radio link monitoring (RLM) measurements, and
reduce monitoring of a physical downlink control channel (PDCCH).

5. The WTRU of claim 1, wherein the processor is further configured to:
on a condition that the WTRU is in the lower layer inactive state,
stop performing radio resource management (RRM) measurements and radio link monitoring (RLM) measurements, and
stop monitoring of a physical downlink control channel (PDCCH).

6. The WTRU of claim 1, wherein the processor is further configured to:
receive configuration information associated with one or more candidate cells, wherein the one or more candidate cells are grouped into one or more candidate cell groups.

7. The WTRU of claim 6, wherein the one or more candidate cell groups comprise a group of cells within a decentralized unit (DU).

8. The WTRU of claim 1, wherein the processor is further configured to:
on the condition that the source cell is associated with the first cell group that is different than the second cell group that the target cell is associated with,
send a request to transition to a lower layer active state,
transition to the lower layer active state, and
send a radio resource control (RRC) complete message.

9. The WTRU of claim 8, wherein the request to transition to the lower layer active state comprises an indication of a cause, the cause associated with a cell re-selection from the first cell group to the second cell group.

10. The WTRU of claim 9, wherein the processor is further configured to receive an indication from the network node to transition to the lower layer active state.

11. The WTRU of claim 2,
wherein the processor is further configured to:
on a condition the WTRU is in the lower layer inactive state,
monitor for an arrival of uplink (UL) data;
determine the WTRU has stored thereon the stored RRC complete message; and
on a condition of the arrival of the UL data,
send a request to transition to a lower layer active state,
transition to the lower layer active state,
send the stored RRC complete message, and
send the UL data.

12. The WTRU of claim 2, wherein the processor is further configured to:
on a condition the WTRU is in the lower layer inactive state,
monitor for an indication of arrival of downlink (DL) data;
determine the WTRU has stored thereon the stored RRC complete message; and
on a condition of a reception of the indication of the arrival of the DL data,
send a request to transition to a lower layer active state,
transition to the lower layer active state,
send the stored RRC complete message, and
receive the DL data.

13. A method comprising:
a wireless transmit and receive unit (WTRU receiving from a network node an indication to transition to a lower layer inactive state;
the WTRU transitioning to the lower layer inactive state;
the WTRU performing measurements associated with cell re-selection;
on a condition, based on the measurements associated with cell re-selection, cell-reselection criteria are satisfied,
the WTRU performing cell-reselection from a source cell to a target cell, and
the WTRU applying a configuration associated with the target cell; and
on a condition that the source cell is associated with a first cell group that is different than a second cell group that the target cell is associated with,
the WTRU sending an indication to a network node indicating the WTRU is connected to the target cell.

14. The method of claim 13, further comprising:
on a condition that the source cell and the target cell are associated with a same cell group, storing an RRC complete message.

15. The method of claim 13, further comprising:
on a condition that the source cell and the target cell are associated with a same cell group, refraining from sending an RRC complete message.

16. The method of claim 13, further comprising:
on a condition that the WTRU is in the lower layer inactive state,
reducing performing radio resource management (RRM) measurements and radio link monitoring (RLM) measurements, and
reducing monitoring of a physical downlink control channel (PDCCH).

17. The method of claim 13, further comprising:
on a condition that the WTRU is in the lower layer inactive state,
stopping performing radio resource management (RRM) measurements and radio link monitoring (RLM) measurements, and
stopping monitoring of a physical downlink control channel (PDCCH).

18. The method of claim 13, further comprising:
on the condition that the source cell is associated with the first cell group that is different than the second cell group that the target cell is associated with,
sending a request to transition to a lower layer active state,
transitioning to the lower layer active state, and
sending an RRC complete message.

19. The method of claim 14, further comprising:
on a condition the WTRU is in the lower layer inactive state,
monitoring for an arrival of uplink (UL) data;
determining the WTRU has stored thereon the RRC complete message; and
on a condition of the arrival of the UL data,
sending a request to transition to a lower layer active state,
transitioning to the lower layer active state, and
sending the stored RRC complete message, and
sending the UL data.

20. The method of claim 14,
on a condition the WTRU is in the lower layer inactive state,
monitoring for an indication of arrival of downlink (DL) data;
determining the WTRU has stored thereon the stored RRC complete message; and
on a condition of a reception of the indication of the arrival of the DL data,
sending a request to transition to a lower layer active state,
transitioning to the lower layer active state,
sending the stored RRC complete message, and
receiving the DL data.
